(19) United States
(12) Patent Application Publication
(10) Pub. No.: US 2009/0060474 A1
(43) Pub. Date: Mar. 5, 2009

(54) BROADCAST RECEIVING APPARATUS AND RECORDING/REPRODUCING METHOD OF PROGRAM

(75) Inventor: Hiroyuki Nakano, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/191,109

(22) Filed: Aug. 13, 2008

(30) Foreign Application Priority Data
Aug. 29, 2007 (JP) 2007-222782

(51) Int. Cl. H04N 7/26

(52) U.S. Cl. 386/124; 386/E05.001

(57) ABSTRACT

According to one embodiment, a broadcast receiving apparatus includes the following module. In other words, the broadcast receiving apparatus includes: a tuner receiving desired program data from a broadcast wave; a recording control module making the program data received by the tuner recorded in a recording medium, with associating the program data with an apparatus code specific for the very apparatus; a program reproducing module reproducing a program by using the program data recorded in the recording medium; a reading module reading the program data and the apparatus code associated with the program data from the recording medium, when the program reproducing module reproduces the program; and a judging module comparing the read apparatus code read from the recording medium by the reading module with the apparatus code and judging reproduction allowabillty about the program data by the program reproducing module.

### CROSS-REFERENCE TO RELATED APPLICATIONS

This application is based upon and claims the benefit of priority from Japanese Patent Application No. 2007-222782, filed Aug. 29, 2007, the entire contents of which are incorporated herein by reference.

### BACKGROUND

1. Field

One embodiment or the invention relates to a broadcast receiving apparatus including a receiving module for TV broadcast such as terrestrial broadcast and satellite broadcast, and a program recording/reproducing method applied to the broadcast receiving apparatus.

2. Description of the Related Art

Conventionally, various types of broadcast receiving apparatuses including receiving modules for TV broadcast such as terrestrial broadcast and satellite broadcast are in practical use. In recent years, widespread is a broadcast receiving apparatus compatible for digital broadcast which receives a broadcast wave of digital broadcast in addition to that of conventional analog broadcast and displays video of a program by using a video signal taken out from the received broadcast wave.

In a conventional broadcast receiving apparatus, by connecting a disk recorder (for example, a hard disk apparatus and the like) which records data by using a disk shaped recording medium such as a hard disk, a DVD-RAM and a DVD-R, it is possible to record video data and also to reproduce video by using the recorded video data.

Meanwhile, the video data the broadcast receiving apparatus obtains by receiving the digital broadcast is digital data, and can be copied without deterioration. Accordingly, there is conventionally disclosed a technology to prevent reproduction of a digital copyrighted work except by an apparatus used for recording, in Japanese Patent Application Publication (KOKAI) No. 2003-131950 (Patent Document 1), for example. In Patent Document 1, a digital copyrighted work protection system is disclosed in which a recording/reproducing apparatus codes the digital copyrighted work by using apparatus-specific information as a key and records it in a recording medium apparatus, and decodes the coded digital copyright work by using the apparatus-specific information as the key.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram showing two digital broadcast receiving apparatuses according to an embodiment of the invention and an HDD as a disk recorder connected thereto;

FIG. 2 is an exemplary block diagram showing a configuration of a network system in the embodiment;

FIG. 3 is an exemplary block diagram showing a main configuration of the inside of a digital broadcast receiving apparatus in the embodiment;

FIG. 4A and FIG. 4B are exemplary diagrams showing an internal configuration of the digital broadcast receiving apparatus or the HDD, FIG. 4A showing a nonvolatile memory and FIG. 4B showing the HDD in the embodiment;

FIG. 5 is an exemplary block diagram showing a configuration related to a recording/reproducing operation in the digital broadcast receiving apparatus in the embodiment;

FIG. 6 is an exemplary flowchart showing operating procedures of a reproduction allowability judgment and a decoding processing in the embodiment;

FIG. 7 is an exemplary flowchart showing operating procedures of reproduction control in the embodiment;

FIG. 8A and FIG. 8B are exemplary tables showing an example of configuration of data recorded in the HDD, FIG. 8A showing a title key table and FIG. 8B showing title data in the embodiment; and

FIG. 9 is an exemplary block diagram showing a configuration related to a recording/reproducing operation in a conventional digital broadcast receiving apparatus in the embodiment.

### DETAILED DESCRIPTION

Various embodiments according to the invention will be described hereinafter with reference to the accompanying drawings. In general, according to one embodiment of the invention, a broadcast receiving apparatus includes the following module. In other words, the broadcast receiving apparatus includes: a tuner receiving desired program data from a broadcast wave; a recording control module making the program data received by the tuner recorded in a recording medium, with associating the program data with an apparatus code specific for the very apparatus; a program reproducing module reproducing a program by using the program data recorded in the recording medium; a reading module reading the program data and the apparatus code associated with the program data from the recording medium, when the program reproducing module reproduces the program; and a judging module comparing the read apparatus code read from the recording medium by the reading module with the apparatus code and judging reproduction allowability about the program data by the program reproducing module.

A program recording/reproducing method of a program applied to a broadcast receiving apparatus including a tuner receiving desired program data from a broadcast wave and a program reproducing module reproducing a program by using the program data recorded in a recording medium includes the following constitution. In other words, the recording/reproducing method of the program includes: making the program data received by the tuner recorded in the recording medium, with associating the program data with an apparatus code specific for the very apparatus; reading the program data and the apparatus code associated with the program data from the recording medium, when the program reproducing module reproduces the program; and comparing the read apparatus code read from the recording medium with the apparatus code and judging reproduction allowability about the program data by the program reproducing module.

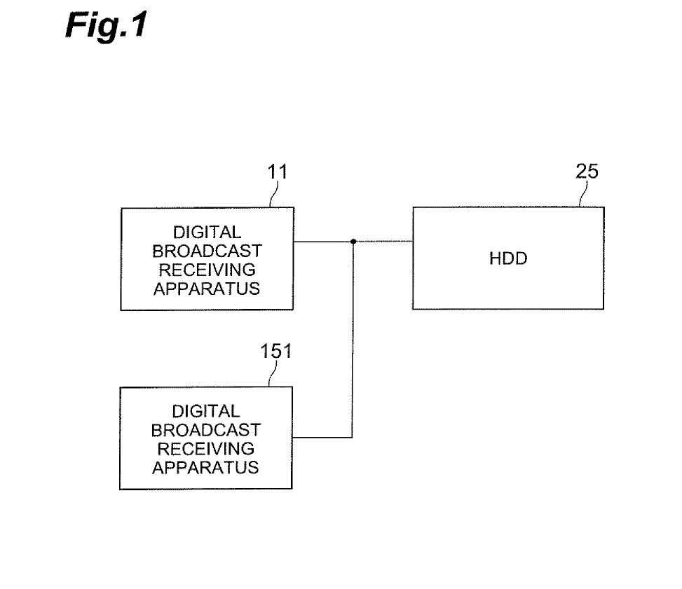

FIG. 1 is a diagram showing digital broadcast receiving apparatuses 11, 151 according to an embodiment of the invention and a hard disk apparatus (HDD: Hard Disk Drive) 25 as a disk recorder connected thereto.

When connected to the HDD 25 respectively, the digital broadcast receiving apparatuses 11, 151 record program data (later-described title data 200) which each receives from broadcast waves in a hard disk of the HDD 25 to perform recording of the programs. It should be noted that since the digital broadcast receiving apparatus 151 has the same constitution as the digital broadcast receiving apparatus 11, description hereinafter will be done centering on the digital broadcast receiving apparatus 11.

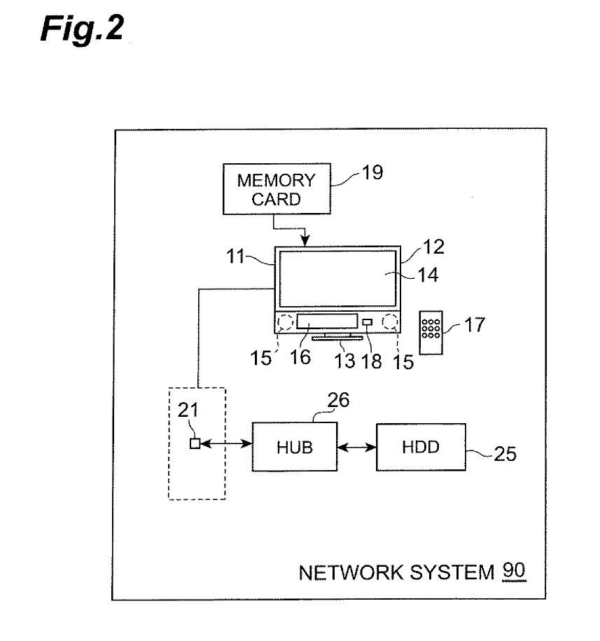

Next FIG. 2 is a block diagram showing a configuration of the digital broadcast receiving apparatus 11 and a network system 90 configured centering on the digital broadcast receiving apparatus 11.

The digital broadcast receiving apparatus 11 includes a cabinet 12 and a support table 13 supporting the cabinet 12 with the cabinet 12 raised, as shown in FIG. 2. The cabinet 12 includes a flat panel type liquid crystal display apparatus 14 having a liquid crystal display panel, a speaker 15 as a sound output unit outputting sound, and an operation part 16, and also includes a light receiving part 18 receiving operation information transmitted from a remote controller 17.

The digital broadcast receiving apparatus 11 is a video display apparatus displaying video by the liquid crystal display apparatus 14 as a video displaying module displaying video, and displays video by using program data a later-described tuner 45 or the like receives from a broadcast wave or program data read from the HDD 25.

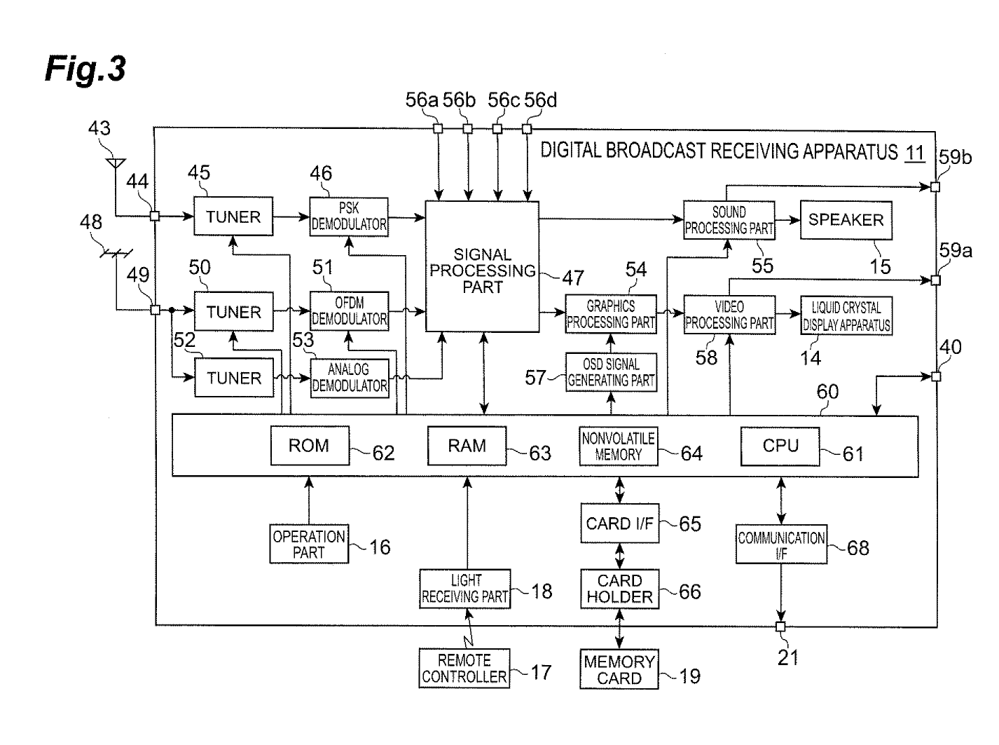

A memory card 19 (see FIG. 3) such as an SD (Secure Digital) memory card or a USB memory is attachable and detachable to and from the digital broadcast receiving apparatus 11, and recording/reproducing of a program, a photograph and the like are performed by using the memory card 19.

The digital broadcast receiving apparatus 11 includes a LAN (Local Area Network) terminal 21. The LAN terminal 21 is used as a general LAN-compatible port in which Ethernet is used. The LAN-connected HDD 25 is connected to the LAN terminal 21 via a hub 26, for example. In addition, apparatuses such as a not-shown PC (Personal Computer), a DVD (Digital Versatile Disk) recorder having a built-in HDD are connected and the LAN terminal 21 is used to perform information transmission with such apparatuses.

Next, a configuration of the inside of the digital broadcast receiving apparatus 11 will be described with reference to FIG. 3. FIG. 3 is a block diagram showing a main configuration of the inside of the digital broadcast receiving apparatus 11.

The digital broadcast receiving apparatus 11 includes input terminals 44, 49, tuners 45, 50, 52 and a PKS (Phase Shift Keying) demodulator 46. The digital broadcast receiving apparatus 11 also includes a signal processing part 47 an OFDM (Orthogonal Frequency Division Multiplexing) demodulator 51, an analog demodulator 53, a graphics processing part 54, a sound processing part 55, an OSD signal generating part 57 and a video processing part 58.

A satellite digital broadcast signal received by a BS/CS digital broadcast receiving antenna 43 is inputted to the input terminal 44. The satellite digital broadcast signal is supplied to the tuner 45 from the input terminal 44. The tuner 45 is a tuner for satellite digital broadcast, and selects and receives a broadcast signal of a desired channel from the satellite digital broadcast signals supplied thereto.

The broadcast signal which is selected by the tuner 45 is supplied to the PSK demodulator 46. The PSK demodulator 46 performs a demodulation processing of digital video signal and sound signal, and outputs the digital video signal and sound signal to the signal processing part 47.

A terrestrial digital broadcast signal received by a terrestrial broadcast receiving antenna 48 is inputted to the input terminal 49. The terrestrial digital broadcast signal is supplied to the tuner 50 from the input terminal 49. The tuner 50 is a tuner for terrestrial digital broadcast, and selects and receives a broadcast signal of a desired channel from the terrestrial digital broadcast signals supplied thereto.

The broadcast signal selected by the tuner 50 is supplied to the OFDM demodulator 51. The OFDM demodulator 51 performs a demodulation processing of digital video signal and sound signal, and outputs the digital video signal and sound signal to the signal processing part 47.

A terrestrial analogue broadcast signal received by the terrestrial broadcast receiving antenna 48 is also inputted to the input terminal 49. The terrestrial analogue broadcast signal is supplied to the tuner 52 from the input terminal 49. The tuner 52 is a tuner for terrestrial analogue broadcast, and selects and receives a broadcast signal of a desired channel from the terrestrial analogue broadcast signals supplied thereto.

The broadcast signal selected by the tuner 52 is supplied to the analogue demodulator 53. The analogue demodulator 53 performs a demodulation processing of analogue video signal and sound signal, and outputs the analogue video signal and sound signal to the signal processing part 47.

The signal processing part 47 selectively applies a predetermined digital signal processing to the digital video signal and sound signal supplied respectively from the PSK demodulator 46 and the OFDM demodulator 51, and outputs the digital video signal and sound signal to the graphics processing part 54 and the sound processing part 55.

A plurality (four in the case of the illustration) or input terminals 56a, 56b, 56c, 56d are connected to the signal processing part 47. These input terminals 56a to 56d are capable of inputting analogue video signals and sound signals thereto from a not-shown DVD recorder and the like as an external apparatus.

This signal processing part 47 selectively digitizes the analogue video signals and sound signals supplied respectively from the analogue demodulator 53 and the respective input terminals 56a to 56d. The signal processing part 47 applies predetermined digital signal processings on the digitized video signals and sound signals, and thereafter, outputs the digitized video signals and sound signals to the graphics processing part 54 and the sound processing part 55.

The graphics processing part 54 superimposes an OSD (On Screen Display) signal generated in the OSD signal generating part 57 on the digital video signal supported from the signal processing part 47, and outputs the superimposed signal. The graphics processing part 54 can selectively output the output video signal of the signal processing part 47 and the OSD signal outputted by the OSD signal generating part 57, and also can combine and output both the outputs so that both the outputs constitute halves of the screen respectively.

The digital video signal outputted from the graphics processing part 54 is supplied to the video processing part 58. The video processing part 58 converts the inputted digital video signal to a video signal in a format displayable in the liquid crystal display apparatus 14, and thereafter, outputs the video signal to the liquid crystal display apparatus 14. The liquid crystal display apparatus 14 displays video by using the video signal. The video signal is reproduced by those signal processing part 47, graphics processing part 54 and video processing part 58, and those constitute a video reproducing module. The video processing part 58 leads the analogue video signal to the outside through an output terminal 59a.

The sound processing part 55 converts the inputted digital sound signal to an analogue sound signal in a format reproducible in the speaker 15r, and thereafter, outputs the analogue sound signal to the speaker 15. The sound processing part 55 also leads the analogue sound signal to the outside through an output terminal 59b.

The digital broadcast receiving apparatus 11 includes a control part 60, a card holder 66 and various kinds of interfaces (card I/F 65, communication I/F 68).

The control part 60 includes a CPU (Central Processing Unit) 61, a ROM (Read Only Memory) 62, a RAM (Random Access Memory) 63 and a nonvolatile memory 64. The control part 60 comprehensively controls the operations of the digital broadcast receiving apparatus 11 including an operation of receiving the broadcast signal. The control part 60 receives operation information from the operation part 16, or receives operation information sent out from the remote controller 17 through the light receiving part 18, and controls each part so that an operation content thereof is reflected.

While the CPU 61 operates as various kinds of modules (recording control module, judging module) in accordance with a program stored in the ROM 62, the CPU 61 performs input/output of the signal from and to other components to perform operation control of the entire digital broadcast receiving apparatus 11.

For example, the CPU 61 performs an operation as the recording control module outputting the program data to the HDD 25 through the communication I/F 68 and makes the program data recorded in the hard disk of the HOD 25. The CPU 61 also performs an operation as the judging module reading the program data recorded in the hard disk of the HDD 25 together with h a later-described apparatus management ID 202 and performing a later-described reproduction allowability judgment by using the read apparatus management ID 202 (read apparatus management ID), and an operation as a reproducing control module instructing the signal processing part 47, the graphics processing part 54, the video processing part 58 and the mike to reproduce the video signal.

The ROM 62 mainly stores a control program to be executed by the CPU 61. The RAM 63 provides a work area to the CPU 61.

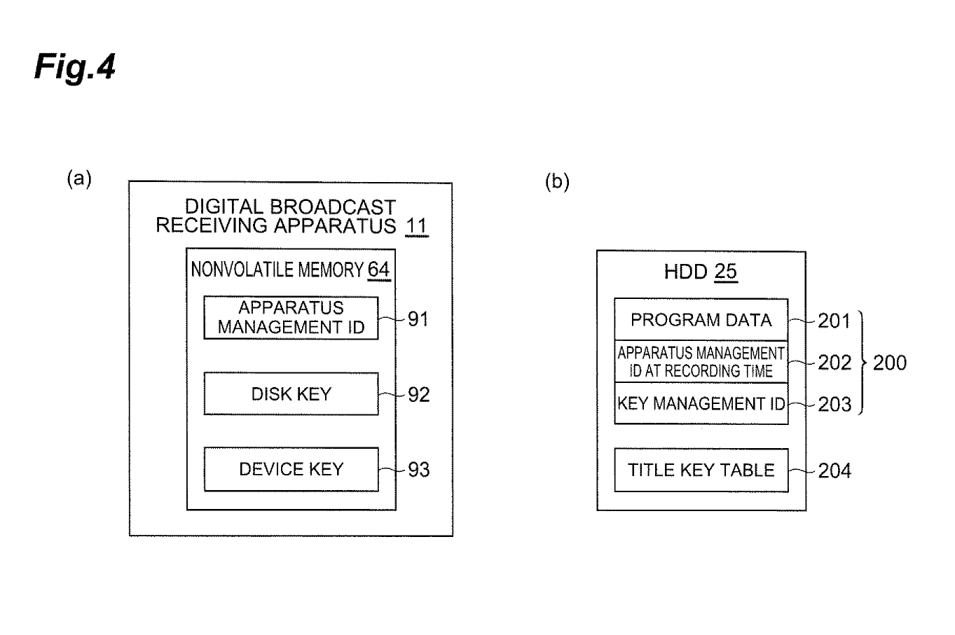

The nonvolatile memory 64 stores an apparatus management ID 91, a disk key 92 and a device key 93, as shown in FIG. 4A, and has a function as an apparatus code storing module.

The apparatus management ID 91 is data specific for the digital broadcast receiving apparatus 11 and is used as an apparatus code specific for the very apparatus, and a MAC (Media Access Control) address can be used d for example. A serial number specific for the very apparatus can also be used as the apparatus management ID 91. The apparatus management ID 91 is stored in the nonvolatile memory 64 at a time of manufacturing the digital broadcast receiving apparatus 11.

The apparatus management ID 91 is collated with the read apparatus management ID 202 read from the HDD 25, when a reproduction allowability judgment is performed.

The disk key 92 is data specific for the HUD 25 connected to the digital broadcast receiving apparatus 11 and is used when coding and decoding a later-described title key table 204. The device key 93 is data specific for the digital broadcast receiving apparatus 11 and used when coding and decoding the title key table 204 coded by the disk key 92.

The control part 60 is connected through the card I/F (Interface) 65 to the card holder 66 to which the memory card 19 is attachable. Thereby, the control part 60 can perform information transmission through the memory card 19 attached to the card holder 66, and the card I/F 65.

The control part 60 is also connected to the LAN terminal 21 through the communication I/F 68. Thereby, the control part 60 can perform information transmission with each apparatus connected to the LAN terminal 21 such as the HDD 25, through the communication I/F 68.

(Description of Operation Content)

Next, an operation content of a recording/reproducing operation performed by the digital broadcast receiving apparatus 11 with the above configuration will be described. In the embodiment, the recording/reproducing operation means a control operation to make the program data recorded in the hard disk of the HDD 25 and a control operation to reproduce the program by using the program data recorded in the hard disk of the HDD 25.

Both of the digital broadcast receiving apparatuses 11, 151 are connected to the HDD 25, and, by the recording/reproducing operation, later-described title data 200 is recorded and the program is reproduced by using the title data 200. Details will be described later.

Here, the title data 200 has, as shown in FIG. 4B, program data 201, the apparatus management ID 202, and a key management ID 203, and the apparatus management ID 202 and the key management ID 203 are recorded with being associated with the program data 201.

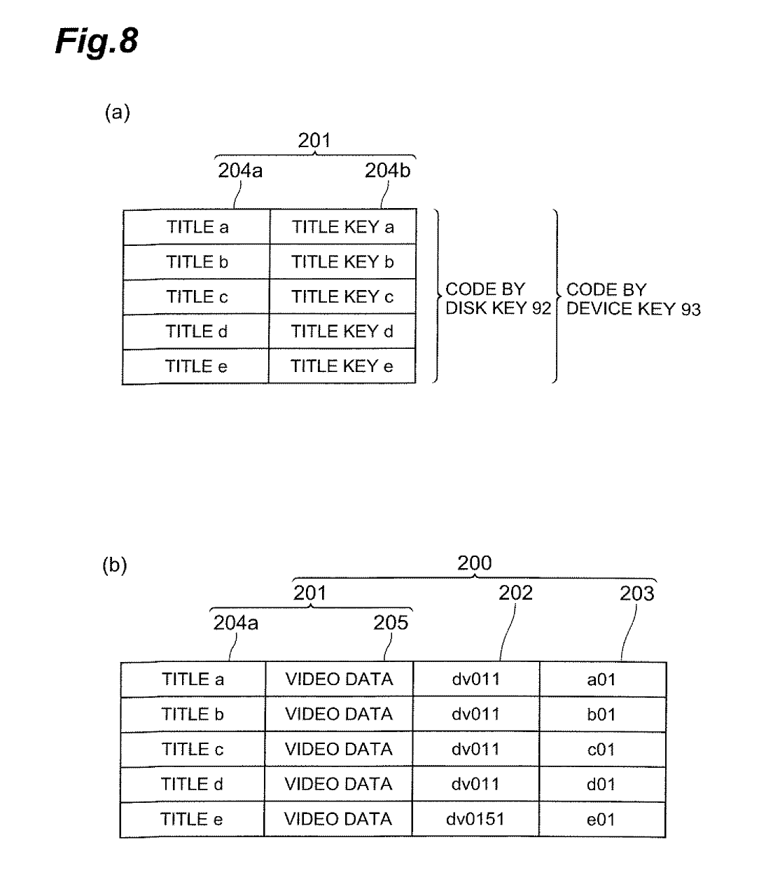

The program data 201 has, as shown in FIG. 8B, a title name 204a and video data 205 for reproducing the program, and is constituted as a file per recorded program. In FIG. 8B, there are shown “dv011” indicating the digital broadcast receiving apparatus 11 and “dv151” indicating the digital broadcast receiving apparatus 151 as the apparatus management IDs 202. The video data 205 is coded by corresponding title keys respectively.

In the HDD 25 is also recorded the title key table 204. The title key table 204 has, as shown in FIG. 8A, the title name 204a and a title key data part 204b, and each title (video data of the recorded program) recorded in the HDD 25 and a title key made by coding each title are recorded correspondingly. The title key table 204 is coded by the above-described disk key 92 and further coded by the device key 93, and recorded in the HDD 2n.

In the digital broadcast receiving apparatus 11, the CPU 61 performs operations as a later-described recording processing cart 100, a coding processing part 101, and a reproducing processing part 102, so that the recording/reproducing operation is realized.

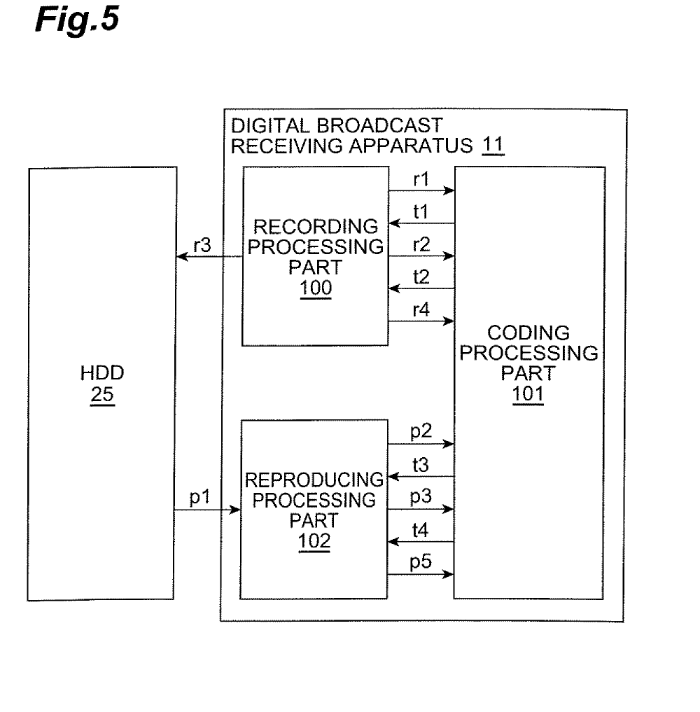

Here, FIG. 5 is a block diagram showing a configuration related to the recording/reproducing operation in the digital broadcast receiving apparatus 11.

An operation in a case that the program data is recorded in the hard disk of the HDD 25 will be described. In this case, first, the recording processing part 10c performs a recording preparation request r1 to the coding processing part 101. When receiving the recording preparation request r1, the coding processing part 101 generates the title key for coding the program data and its managing TD (key management ID). The coding processing part 101 reads the apparatus management ID 91 from the nonvolatile memory 64 in correspondence with the generating of the title key and the key management ID, and further performs an output t1 to output the key management ID and the apparatus management ID 91 to the recording processing part 100.

Subsequently, the recording processing part 100 performs an output r2 to output the program data to be recorded in the hard disk of the HDD 25 to the coding processing part 101. Then, the coding processing part 101 performs an operation as a coding module and codes the received program data by using the generated title key and further performs an output t2 to output the coded program data to the recording processing part 100.

Then, the recording processing part 100 operates as a recording control module, and performs recording control r3 to the HDD 25, and makes the program data (coded program data), having been coded recorded in the hard disk with associating the program data with the apparatus management ID 91 and the key management ID.

Thereby, in the hard disk of the HDD 25, the above-described title data 200 is recorded. In this case, the program data is recorded as the program data 201, and the apparatus ID 91 is recorded as the apparatus ID 202 while the key management ID is recorded as the key management IS 203 respectively.

Thereafter, the recording processing part 100 performs a recording termination notification r4 and notifies the coding processing part 101 of recording termination of the program data.

Next, operations in a case that the program is reproduced by using the program data recorded in the HDD 25 will be described. In this case, first, the reproducing processing part 102 performs an operation as a reading module and performs a data reading p1 from the hard disk of the HDD 25. In the data reading p1, there are read the program data 201 to be used for reproducing of the program and the apparatus management ID 202 and the key management ID 203 which are recorded with being associated with the program data 201.

Subsequently, the reproducing processing part 102 performs a reproducing preparation notification on p2 and notifies the coding processing part 101 of the apparatus management ID 202 (this is equivalent to a read apparatus code) and the key management ID read from the HDD 25.

When receiving the reproducing preparation notification p2, the coding processing part 101 performs later-described reproduction allowability judgment and decoding processing by using the notified apparatus management TD 202 and so on, and performs a notification t3 notifying the reproducing processing part 102 of a judgment result of the reproduction allowability.

On the other hand, the reproducing processing part 102, depending on the judgment result notified by the coding processing part 101, performs an output p3 when reproducible, to output the coded program data 201 to the coding processing part 101.

When the program data 201 is outputted from the reproducing processing part 102, the coding processing part 101 decodes the program data 201 by using the title Key corresponding to the key management ID having been notified in the notification p2 and performs an output t4 of outputting the decoded program data 201 to the reproducing processing part 102.

The reproducing processing part 102 controls reproducing of the program by the signal processing part 47 and the like by using the program data 201 outputted from the coding processing part 1011 and performs a notification p5 when the reproducing is terminated and notifies the coding processing part 101 that the reproducing is terminated.

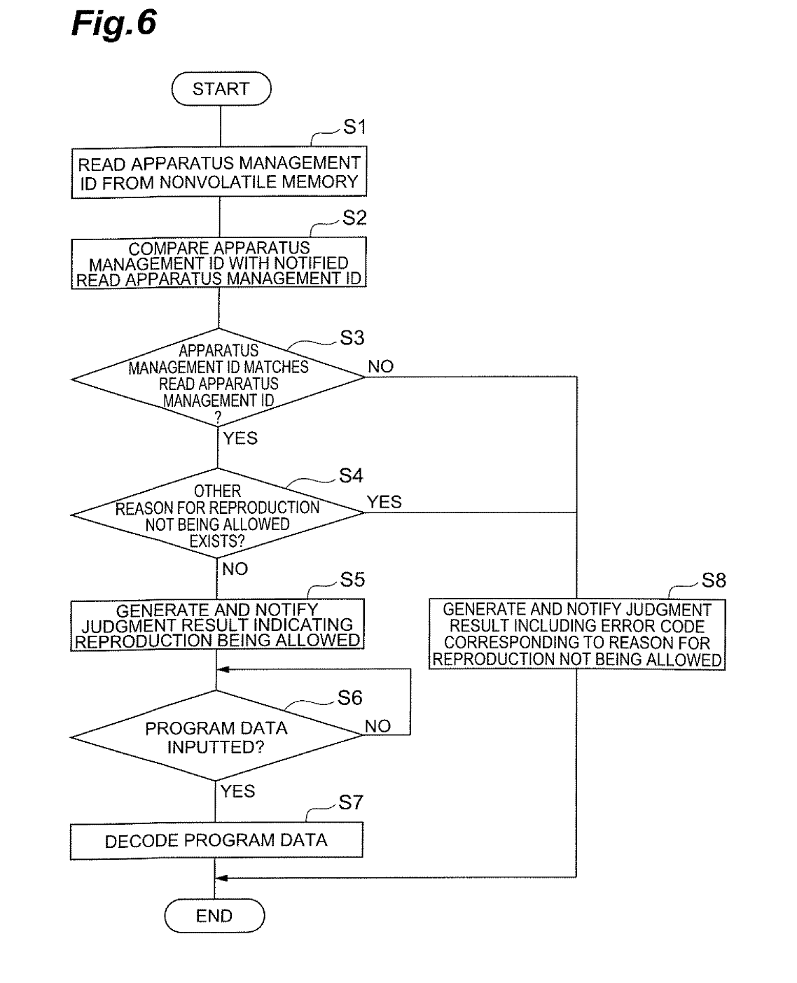

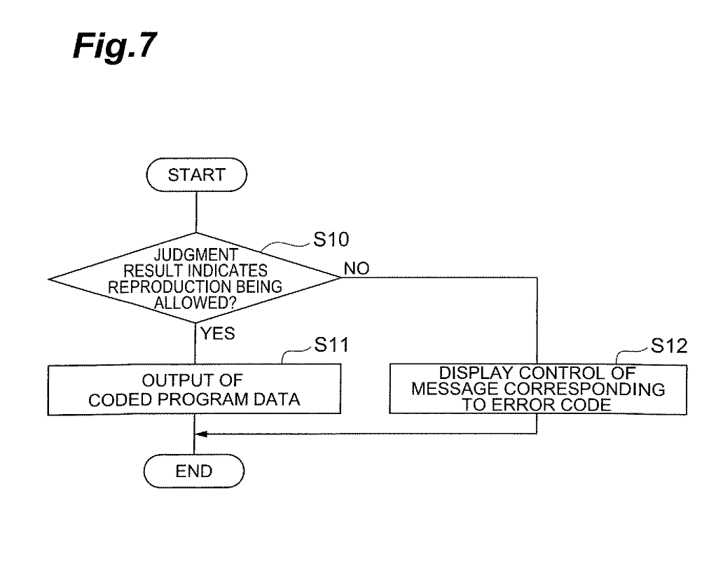

In the above-described series of operations, the coding processing part 101 performs the reproduction allowability judgment and the decoding processing in accordance with a flowchart shown in FIG. 6, while the reproducing processing part 102 performs the reproducing control in accordance with a flowchart shown in FIG. 7

In other words, when receiving the reproducing preparation notification p2, the coding processing part 101 first reads the apparatus management TD 91 from the nonvolatile memory 64 (S1). Subsequently, is the coding processing part 101 performs a collating processing of comparing the apparatus management ID 91 read from the nonvolatile memory 64 with the apparatus management ID 202 as the read apparatus code which is notified by the reproducing processing part 102 (S2) and judges whether or not both match each other in subsequent S3. The coding processing part 101 proceeds the operation to S4 when the apparatus management ID 91 matches the apparatus management ID 202 and otherwise proceeds the operation to S8.

When proceeding the operation to S4, the coding processing part 101 judges whether or not there exists another cause (for example, the program data recorded in the HDD 25 is broken) of reproduction not being allowed, about the program data. The coding processing part 101 proceeds the operation to SE when another cause of the reproduction not being allowed exists. The coding processing part 101 proceeds the operation to S5 when another cause does not exist, and generates a judgment result indicating the reproducing being allowed and notifies the reproducing processing part 102 (above-described notification t3).

The coding processing part 101 waits until the program data is inputted from the reproducing processing part 102 in subsequent S6, and if the program data is inputted, the coding processing part 101 proceeds the operation to S7 and decodes the program data by using the title key corresponding to the key management ID having been notified in the notification p2, and then terminates the reproducing allowability judgment and the decoding processing.

When proceeding the operation from S3 to 56, the coding processing part 101 performs an operation as an error code generating module and generates a judgment result including an error code corresponding to a reason for the reproducing not being allowed and notifies the reproducing processing part 102 (above-described notification t3). In this case, if the apparatus management ID 91 does not match the apparatus management ID 202, the coding processing part 101 generates an error code indicating apparatus discrepancy in which the apparatus having received the program data from the broadcast wave is different from the apparatus to be used for reproducing (for example, in a case that the digital broadcast receiving apparatus 151 reproduces the program by using the program data 201 recorded in the HOD 25 from the digital broadcast receiving apparatus 11), and when a reason other than the apparatus discrepancy exists, the coding processing part 101 generates an error code corresponding to a content thereof.

On the other hand, in a case that the reproducing processing part 102 performs a reproducing control, as shown in FIG. 7, it is judged whether or not the judgment result notified in the notification t3 is the one indicating the reproducing being allowed (S10). If the result is the one indicating the reproducing being allowed, the reproducing processing part 102 proceeds the operation to S11, and otherwise the reproducing processing part 102 proceeds the operation to S12. When proceeding to S11, the reproducing processing part 102 outputs the program data 201 (above-described output p3), and when proceeding to S12, the reproducing processing part 102 performs a display control of a message corresponding to the error code.

As stated above, by performing the recording/reproducing operation, in the digital broadcast receiving apparatus 11, the apparatus management ID 91 specific for the digital broadcast receiving apparatus 11 is recorded with being associated with the program data when the program data is recorded in the hard disk of the HDD 25. Meanwhile, when the program is reproduced, the apparatus management ID 202 recorded in the HDD 25 with being associated is read and collated with the apparatus management ID 91 stored in the nonvolatile memory 64.

Thereby, the coding processing part 101 can judge reproduction allowability at a time of receiving the reproducing preparation notification p2 from the reproducing processing part 102, and therefore the reproduction allowability of the program can be judged without decoding the coded program data. Thus, a processing load at a time of reproducing the recorded program can be reduced in the digital broadcast receiving apparatus 11.

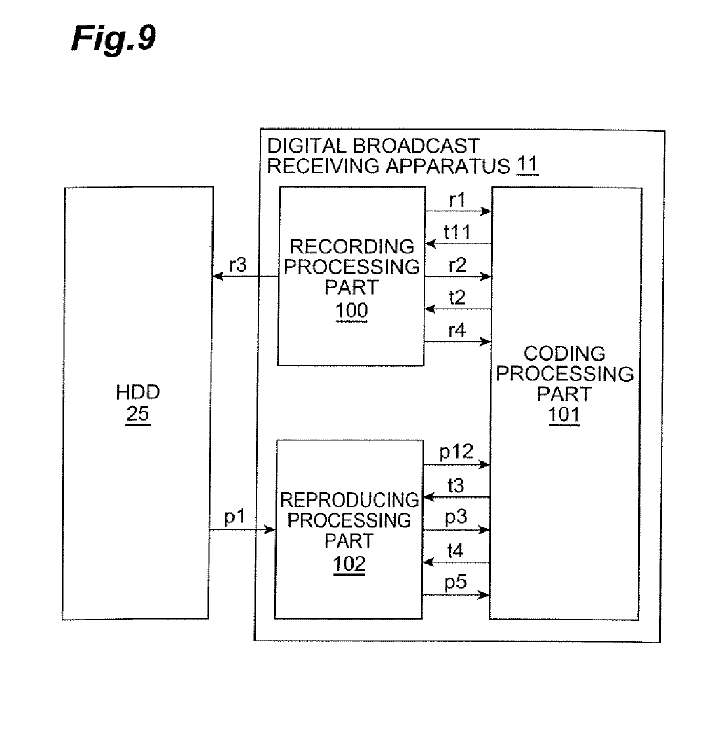

Here, a configuration related to a recording/reproducing operation in a conventional digital broadcast receiving apparatus is shown in FIG. 9. The conventional digital broadcast receiving apparatus is different from the digital broadcast receiving apparatus 11 in that in the conventional digital broadcast receiving apparatus an output t11 and a reproducing preparation notification p12 are performed instead of the above output t1 and reproducing preparation notification p2. In the output t11, a key management ID is outputted to a recording processing part 100, while in the reproducing preparation notification p12 the key management ID is notified. An output or a notification of an apparatus management ID is not performed in either thereof.

A coding processing part 101 decodes program data without performing reproduction allowability judgment (S2, S3) by using the apparatus management ID 91 as above so that a reproducing processing part 102 must judge the reproduction allowability by analyzing the program data outputted in an output t4. Therefore, a decoding processing to break cipher is required also for program data which cannot be decoded in principle.

However, in the digital broadcast receiving apparatus 11 according to the embodiment, as described above, by performing the reproduction allowability judgment (S2, S3), a program whose cipher cannot be broken and a program whose cipher can be broken are distinguished, and as for program data which cannot be decoded in principle, a processing of actually decoding and analyzing the program data can be omitted, so that the processing load can be reduced.

Further, in the digital broadcast receiving apparatus 11, since the error code indicating the result of the reproduction allowability judgment is generated, the reason for the reproduction being allowed/not allowed becomes clear, so that it is possible to make clear whether or not reproduction is not allowed due to apparatus discrepancy.

The above embodiment is described with the digital broadcast receiving apparatus 11 as a television receiving apparatus having the liquid crystal display apparatus 14 being taken as an example of the broadcast receiving apparatus, but the embodiment can also be applied to a broadcast receiving apparatus having a tuner such as a DVD player and a DVD recorder and capable of recording or reproducing video data.

Further, a case that the HUD is connected as the disk recorder to the digital broadcast receiving apparatus 11 is exemplified, the invention can also be applied to a case that a disk recorder using an optical disk such as a DVD-R and DVD-RAM is connected.

The description in the above is to describe the embodiments of the invention and, in no case, limits the apparatus and method of the invention, so that various modifications can be embodied with ease. Further, the device and method structured by appropriately combining the components, the functions, the features or the steps of the method in the respective embodiments are also within the scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast receiving apparatus comprising:
a tuner receiving desired program data from a broadcast wave;
a recording control module making the program data received by said tuner recorded in a recording medium, with associating the program data with an apparatus code specific for the very apparatus;
a program reproducing module reproducing a program by using the program data recorded in the recording medium;
a reading module reading the program data and the apparatus code associated with the program data from the recording medium, when said program reproducing module reproduces the program; and
a judging module comparing the read apparatus code read from the recording medium by said reading module with the apparatus code and judging reproduction allowability about the program data by said program reproducing module.

2. The broadcast receiving apparatus according to claim 1, further comprising
an apparatus code storing module storing the apparatus code, wherein
said judging module compares the read apparatus code with the apparatus code stored in said apparatus code storing module and judging the reproduction allowability.

3. The broadcast receiving apparatus according to claim 1, further comprising
an error code generating module generating an error code corresponding to a reason for the reproduction being not allowed, when a judgment result of said judging module indicates the reproduction being not allowed about the program data.

4. The broadcast receiving apparatus according to claim 3, wherein
said error code generating module generates the error code in a manner to indicate apparatus discrepancy in which the apparatus having received the program data from the broadcast wave is different from the apparatus to reproduce the program, when the Judgment result of said judging module indicates discrepancy between the read apparatus code and the apparatus code stored in said apparatus code storing module.

5. The broadcast receiving apparatus according to claim 1, further comprising
a coding module coding the program data, wherein
said recording control module makes the coded program data coded by said coding module recorded in the recording medium with associating the coded program data with the apparatus code.

6. The broadcast receiving apparatus according to claim 1, further comprising
a video displaying module displaying video by using the program data.

7. A program recording/reproducing method of a program applied to a broadcast receiving apparatus comprising a turner receiving desired program data from a broadcast wave and a program reproducing module reproducing a program by using the program data recorded in a recording medium, the program recording/reproducing method of the program comprising:
making the program data received by the tuner recorded in the recording medium, with associating the program data with an apparatus code specific for the very apparatus;
reading the program data and the apparatus code associated with the program data from the recording medium, when the program reproducing module reproduces the program; and
comparing the read apparatus code read from the recording medium with the apparatus code and judging reproduction allowability about the program data by the program reproducing module.
